(19) United States
(12) Patent Application Publication
(10) Pub. No.: US 2002/0178183 A1
(43) Pub. Date: Nov. 28, 2002

(54) Data extraction method and apparatus

(76) Inventor: Uwe Meding, Allen, TX (US)

Correspondence Address: CARR LAW FIRM, L.L.P., 670 FOUNDERS SQUARE, 900 JACKSON STREET, DALLAS, TX, 75202, US

(21) Appl. No.: 09/829,775

(22) Filed: Apr. 10, 2001

(51) Int. Cl. G06F 15/00; G06F 17/00; G06F 17/21; G06F 17/24

(52) U.S. Cl. 707/509; 707/526; 707/517

(57) ABSTRACT

Disclosed is an apparatus for and method of extracting or mining data from a visually displayable file using quads to enclose textual symbols and graphics where tables of data are detected and processed differently than straight text or text and graphics. Quads enclosing textual symbols and graphics are oversized and overlapping quads are assembled into frames. Each frame is then treated as a separate title, paragraph, graphic or table in accordance with an analysis of the extracted material. An output (mined) document is then created that may be used by word processing and web browser programs to display, print or transport the mined material.

### TECHNICAL FIELD

The present invention relates to deciphering and extracting different types of visually displayed text and graphics information that has been decomposed for presentation by a visual display program and presenting same in a generated destination document of a different format.

### BACKGROUND

To visually display information on a computer screen, some programs insert text, data and graphics characters and symbols into non-visible receptacles or containers. These containers or receptacles may then be axially oriented and positioned on the screen to display the information to be presented.

An example of one such visual display program is named ACROBAT® READER and is typically referred to as a pdf (portable document format) file interpreter by those skilled in the art. This display program was originated by Adobe Systems Incorporated (hereinafter referred to as ADOBE®). Files produced in accordance with ADOBE standards are produced in a manner proprietary to ADOBE® with the letters “pdf” at the end of the file name.

In a pdf file, each word, number, phrase or word portion may be contained in a separate receptacle designated by ADOBE® as a “quad.” This term will be used for convenience in designating any data holding container for all visual display programs.

Various portions of a graphic, or even word enhancement items, such as underlining, overbars and the like, may be included within separate quads. Likewise, when a table is presented in a pdf file, each of the lines used to generate the cells of a table may be enclosed in separate quads. Since a line is considered in such a file to be a graphic rather than text, the line itself is represented by a polygon. For a straight line, this polygon would be a rectangle defining the sides and ends of the line. When a portion of a word or phrase used to present information to a reader is in a different font and/or a different vertical location, such as subscripted or superscripted characters, a different quad is used. For example, a different quad is used for the subscript character(s) than is used to display the subscripted information. In other words, for the expression “Volt_{ac}”, “Volt” would be contained in a first quad in close proximity to, but separate (not physically touching each other, but adjacent) from a quad containing the actual subscript characters “ac”. The quad containing “ac” would have the same orientation as would the quad containing “Volt,” but would typically have a different font size and be located in a slightly lower position than the quad containing “Volt.” In a similar manner, a label such as PCI_ADO is likely to be separated into two or more quads because of the underline symbol. It should be noted that the physical space or shape of the quads is not visually apparent to a viewer, and that the subscripted characters do not visually appear to be separated from the subscripts.

Other compilations of data, such as formulas and other mathematical expressions, presented by the ACROBAT® READER from a pdf file may visually appear to have contiguous symbols, but in fact may well comprise a plurality of quads to properly present brackets, exponentials, underlining, overbars, quotes, and other such mathematical symbols. When a set of characters in a quad further use a graphic symbol, such as an overbar, the boundaries of the graphic quad at least intersect and typically are located completely within the quad containing the set of characters that the overbar is intended to modify or accent.

Visual display program files have also been used to present limited graphical information. One such example is a specification sheet for an electronic component having labeled pin numbers completely surrounding the inside of a visually displayed rectangle. Typically, the labels are on the outside of the rectangle and the pin numbers are near, but on the inside, of the rectangle. Further, the labels and pin numbers associated with the sides of the component are horizontally oriented, while the ones on the top and bottom are vertically oriented. Very often some of the labels include subscripts. Other labels may be broken into multiple quads for other reasons.

The visual display may also include tables of information having text and data in horizontally and vertically contiguous cells where the cells are typically enclosed by graphically displayed lines. The data in a given cell is typically related to data in an adjacent cell that is either horizontally or vertically displaced from the given cell. Further, the data displayed may be related to data that is both horizontally and vertically displaced cells. The orientation of related data is dependant upon both the type of data displayed and the thought process of the person originally compiling the table of data for display. In such a display, not only are the words or word portions contained in separate quads, each of the four graphic lines surrounding each cell will be contained in separate quads.

By definition, for the rest of this document, visually contiguous character sets, such as subscripts, superscripts and other character entities that are associated with but placed in different programming receptacles or quads than their subscripted, superscripted or like characters, are included within the phrase “associated characters.” The terms “associated characters” or “word sets” likewise are intended to include portions of formulas or word phases that are placed in different and/or separate quads, as well as items like overbars, quotes, brackets, numbers, accent characters, underlining, and so forth, that may be used in ordinary text and causes the visual display program to break the character set into separate containers for display.

In the past, the extraction of text from specification sheets has typically been accomplished by retyping from an original or copy of that specification sheet. Another method has been to display the material on a computer screen and select, copy and paste material from a source document to a destination document. While the last mentioned approach has, in some cases, been more accurate than retyping, the pasted material in the destination document requires considerable modification and reorganization and is often slower than retyping in the first place. Thus, the select, copy and paste method is still so labor intensive, it is seldom used.

A patent application Ser. No. 09/594,052, filed Jun. 14, 2000 in my name, entitled “DATA MERGE AND EXTRACTION METHOD AND APPARATUS” and assigned to the same assignee as the present invention, describes a method of extracting data from a selected area on a visual display that comprises a representation of a component having pin labels and number assignments. The extraction of data within the selected area, as set forth in this application, involved combining text from certain quads as a related first set of data, while segregating same from one or more other sets of text aligned with and having an orientation that is the same as the first set of extracted data.

It would be desirable to have a program or process through which a user can select a range of material in a multi-page document and differentiate between components, tables, graphics that may be kept or discarded, and text not associated with graphics. It would further be desirable that the program be able to extract general text data in a manner that can distinguish between general text and text titles.

It would also be desirable to be able to generate a destination or output document that maintained all graphics related text with the associated graphics for some identified objects, such as a table, while disassociating the text from the graphics for other identified objects, such as component layouts. An example of such disassociation comprises providing a spread sheet or table type listing comprising pin labels, associated pin numbers, pin polarity indications, relative pin positions for a group of pin tuple, and so forth, presented in a form readily useable by other programs such as CAD (computer aided design) programs and/or a computer user or operator. In this manner, all data relative a given pin may be contained in a database record or row of the spreadsheet. All data of the same type, such as merged pin labels, may then be placed in the same field or column, respectively.

Since the source document may illustrate graphics, such as tables and components interspersed with a range of text, it would be further desirable to be able to selectively present the text frame in the destination document as shown in the source document or as text separated from graphics.

### SUMMARY OF THE INVENTION

The present invention comprises an apparatus for and a method of detecting different types of data in a visually displayed document, such as tables, components and associated text, that may have unwanted graphics interspersed therein, and retrieving each type of data in a different manner for application to a destination document.

### BRIEF DESCRIPTION OF THE DRAWINGS

For a more complete understanding of the present invention, and its advantages, reference will now be made in the following Detailed Description to the accompanying drawings, in which:

FIG. 1 is a flow diagram of the overall data extraction process;

FIGS. 2 through 8 are additional flow diagrams providing more detail relative the extraction block of FIG. 1;

FIGS. 9A and 9B provide a representation of a visual display file from which data is to be extracted;

FIG. 10 is a representation of the table portion of FIG. 7 after extraction by the mining process of FIG. 1 and upon display using the extracted data;

FIG. 11 provides detail for use in conjunction with explaining the quad expansion and merging of FIG. 2;

FIG. 12 comprises a representation of a table presented in FIG. 9B wherein the lines are exaggerated in width to facilitate an explanation of the flow diagram of FIGS. 3, 4 and 5;

FIGS. 13 and 14 provide more detail of a portion of FIG. 12 for use in describing the co-aligned line combining line extension and rectangle splitting of FIGS. 4 and 5;

FIGS. 15 through 18 illustrate the creation of an output document table and are used in explaining the flow diagram of FIG. 5;

FIG. 19 presents a block diagram of a computer system upon which the present invention may be utilized;

FIG. 20 is a flow diagram providing the steps involved in adding virtual cut-lines to a table having multiple data items in a cell, but not having such dividing lines in the source document; and

FIG. 21 is a table used in explaining the flow diagram of FIG. 20.

### DETAILED DESCRIPTION

A related patent application has previously been filed in my name and assigned to the same assignee as the present application. The application is entitled “DATA MERGE AND EXTRACTION METHOD AND APPARATUS,” which was filed Jun. 14, 2000 and assigned Ser. No. 09/594,052. This referenced application relates to decrypting or reuniting visual display selected text and graphics information that has been decomposed for presentation by a visual display program and presenting same in a generated destination document of a different format. I hereby incorporate the teachings of the referenced invention into this application in its entirety and for all purposes. The present invention comprises an enhancement of the referenced invention in that the referenced invention required a user to delineate specific types of material to be mined, where “mined” by definition in this document refers to the process of extracting data from a visually displayable document or file whereby it may be displayed or otherwise generated in other environments and formats. The process of displaying comprises all forms of display, including printed and screen display. The present invention uses some of the “quad” expansion and merge techniques used in the referenced invention to combine all associated quads forming a paragraph or frame of data. Similar quad expansion and merge techniques are used to generate frames of data comprising graphics or tables in the present invention, as will be discussed in the following description and operational discussion. The present invention enhances the teachings of the referenced invention by being able to examine a range of material covering multiple pages of visually displayed data and determine which frames of data comprise tables of data, which frames comprise only text, which frames comprise only graphic material and which frames comprise both graphic material and text. After the examination, a determination may then be made as to which data should be visually provided to the user setting the range to be examined. As part of the process, the mined document is formatted (or written in a manner) to be interpreted for visual or printed display by some program. In a preferred embodiment of this invention, the format was “XML” (extensible Markup Language), an extended version of “html” (HyperText Markup Language), so that it could not only be read directly by most word processing and spreadsheet programs, but would also be directly usable by WWW (world wide web) browsers. More information on the governing standards body (World Wide Web Consortium (W3C)) for XML may be found at “http//www.w3c.org”.

Further, the present invention is able to keep material in separate paragraphs and titles, unlike prior attempts to mine data. In other words, if more than one paragraph of text were selected, all the text in the selected multiple paragraphs would be combined into one paragraph. Thus in the prior art mining, each paragraph and title needed to be selected manually. It should be noted that for the purposes of this document, the term textual symbol includes not only textual characters like “a,” “b” and “c,” but additionally includes textual modifiers like underlining, quotes, question marks (“?”), overbars, and accent marks.

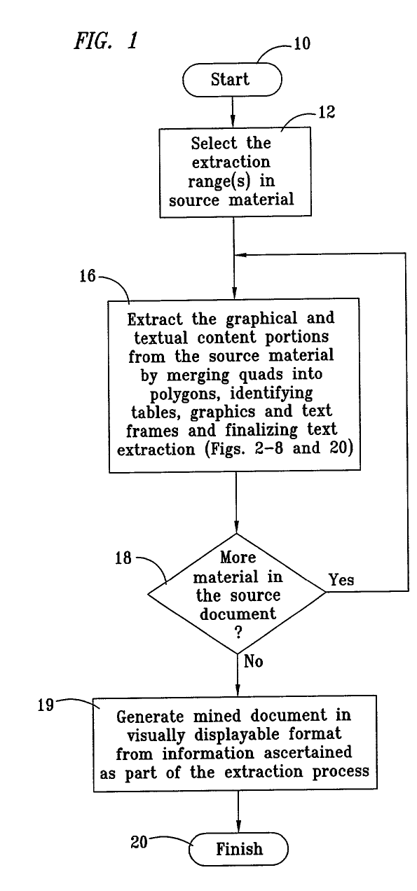

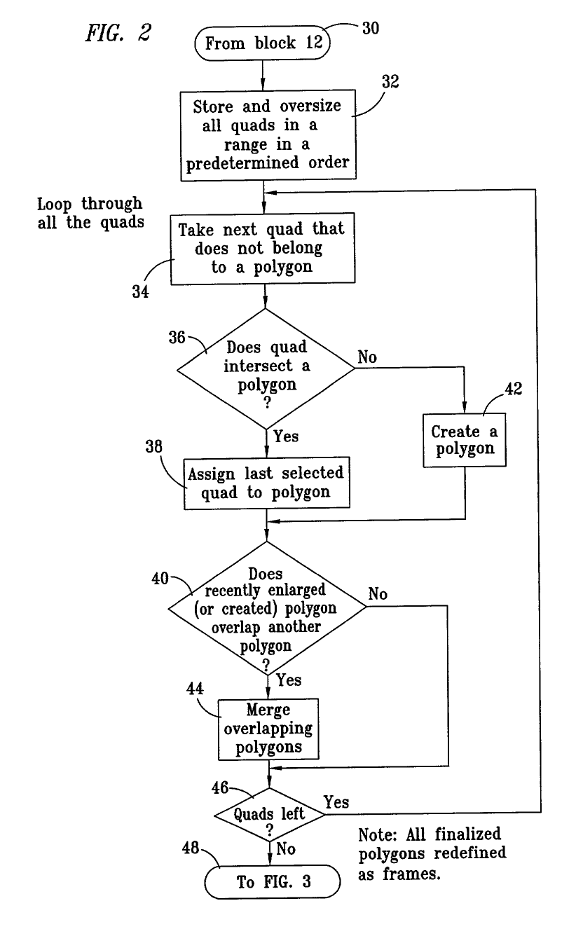

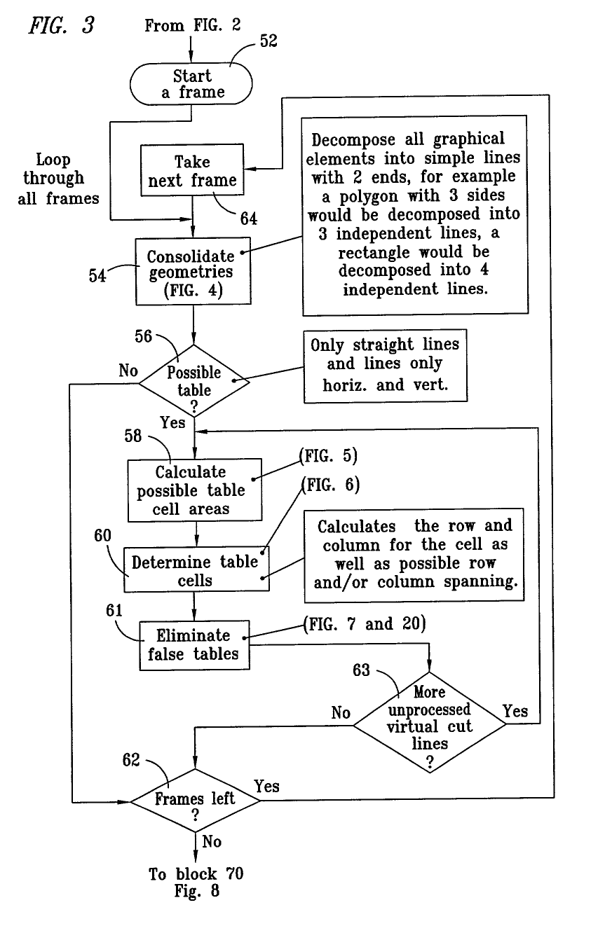

In FIG. 1, the process for practicing the present invention starts with a block 10 and flows to a block 12 where a user selects a range (which may be many visually presented pages) of material to be examined of the source material. The data delineated or selected by block 12 is examined in block 16, identified as to type of data, and the text portions are appropriately formatted as set forth in more detail in following FIGS. 2 through 8 and 20. The process then continues to a decision block 18 where a determination is made as to whether or not there is more material in the source document which has not been examined as part of this process. If so, the process returns to block 14 to extract information from a further portion of the source document. If there is no more material, the process is passed to a block 19 where a mined document is generated in visually displayable format from information obtained during the extraction process of block 16. The process is then finished as stated in a block 20.

In FIG. 2, a block 30 proceeds from the selection step of block 12 in FIG. 1 and continues to a block 32 where a process is commenced to store and oversize all quads in the range set forth in block 12 of FIG. 1. As set forth in the referenced patent application, a “quad” is a term used by Adobe Systems Incorporated (hereinafter referred to as ADOBE®) in conjunction with their version of a visual display file typically referred to in the art as a pdf file. In a pdf file, each word, number, phrase, or word portion may be contained in a separate receptacle designated by ADOBE® as a “quad.” This term will be used hereinafter for convenience in designating any data holding container for all visual display programs. This data includes at least graphics, text and lines, whether straight or curved. The storing and over-sizing may be accomplished in a manner substantially identical to the process set forth in the referenced patent application.

An iterative process is then commenced to loop through all the quads in the range starting with a block 34 wherein a quad is selected that does not presently comprise part (is not presently assigned to a polygon) of a polygon. In a decision block 36, a determination is made as to whether or not the “real estate” covered by the expanded quad in fact intersects a polygon. If it does intersect a polygon, that quad is assigned to the polygon it intersects in a block 38. The process then continues to a decision block 40. However, if, in block 36, a determination is made that there is no intersection with any polygon, the process, in a block 42, creates a polygon encompassing the quad selected in block 34 and proceeds to a block 40. In block 40, a determination is made as to whether or not the recently enlarged polygon of block 38, or the newly created polygon of block 42, overlaps another existing polygon; if so, the two overlapping polygons are merged in a block 44 before proceeding to a decision block 46. If it is determined in block 40 that there is no overlapping, the process goes directly from block 40 to a block 46. In block 46, a determination is made as to whether or not there are any more quads in the range being examined, not assigned to a polygon. If there are, a return is made to block 34 where another quad is selected. If all quads are contained within expanded polygons, the process continues to a block 52 in FIG. 3. For the remainder of the process, the area (or real estate) included within the expanded polygons established in FIG. 2 will be referred to or otherwise re-defined as frames.

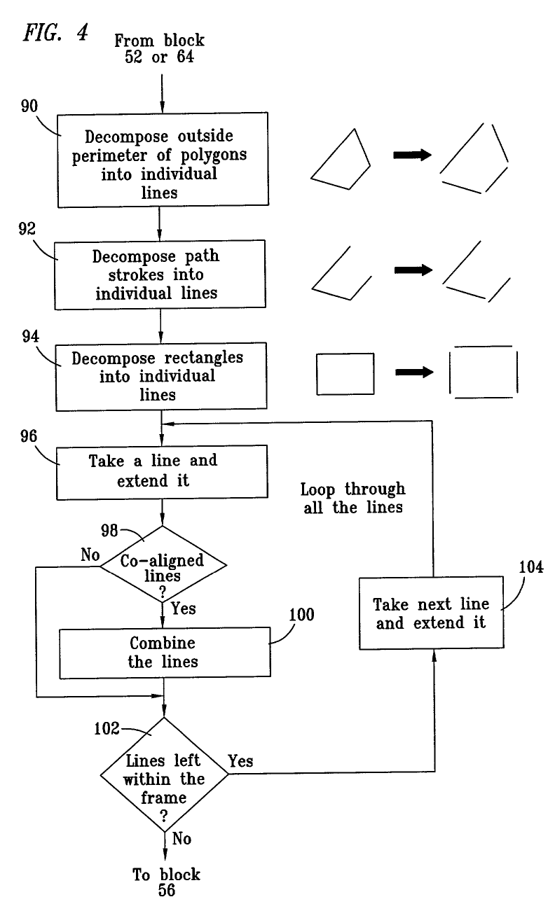

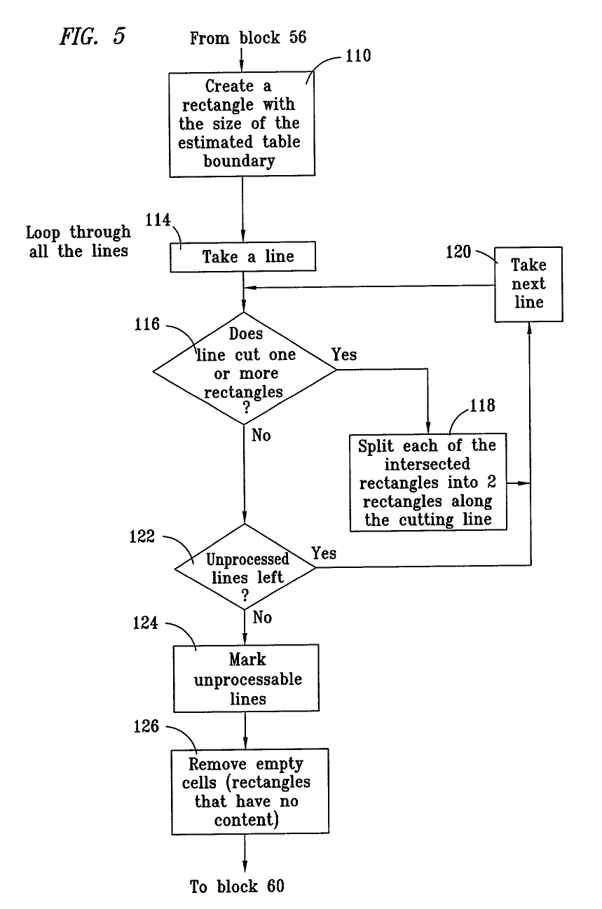

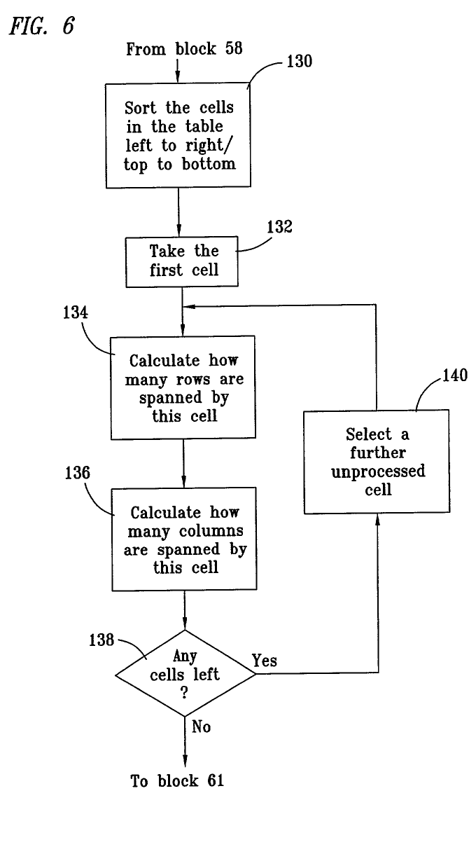

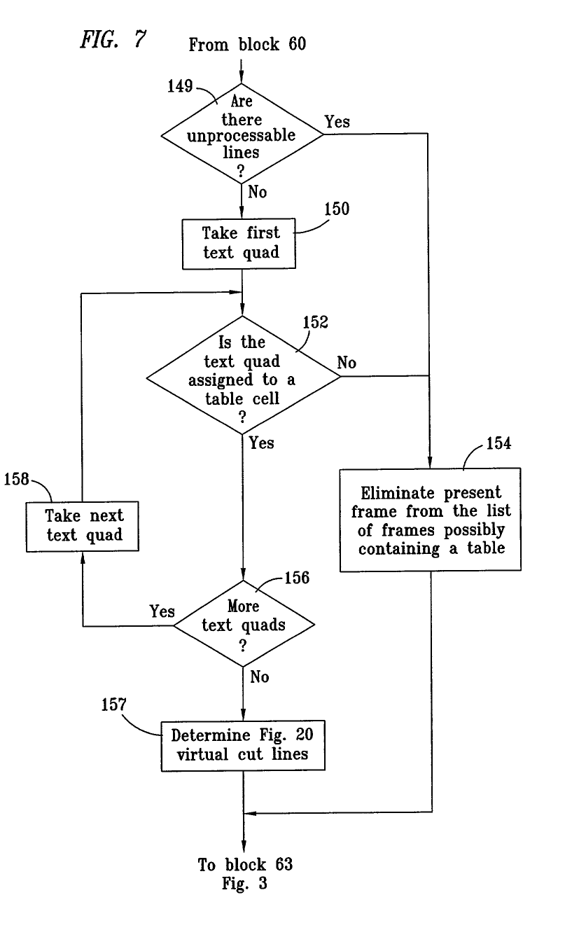

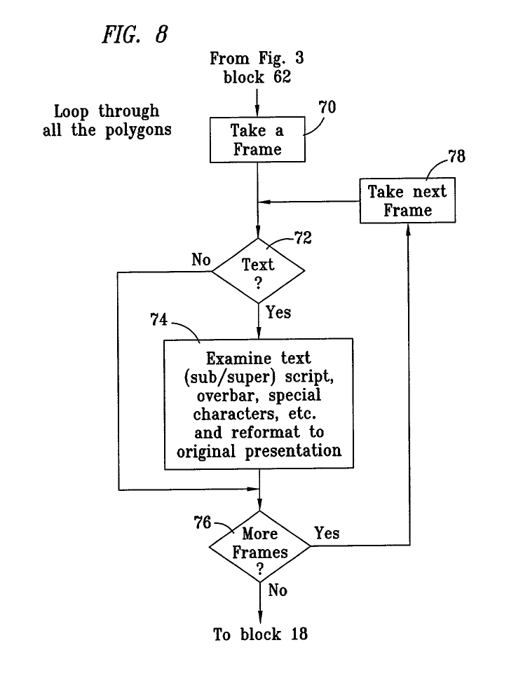

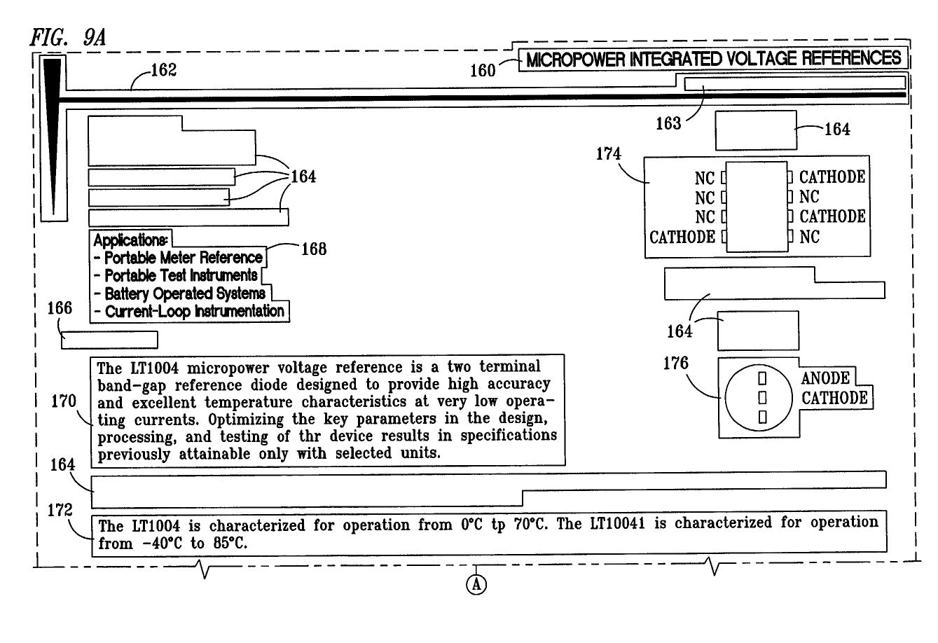

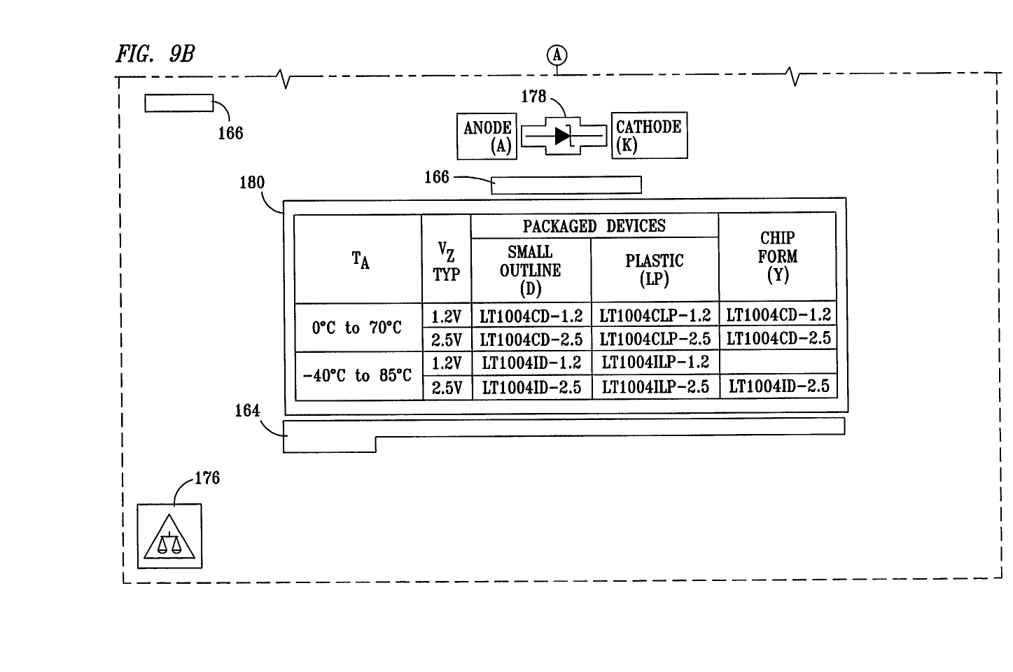

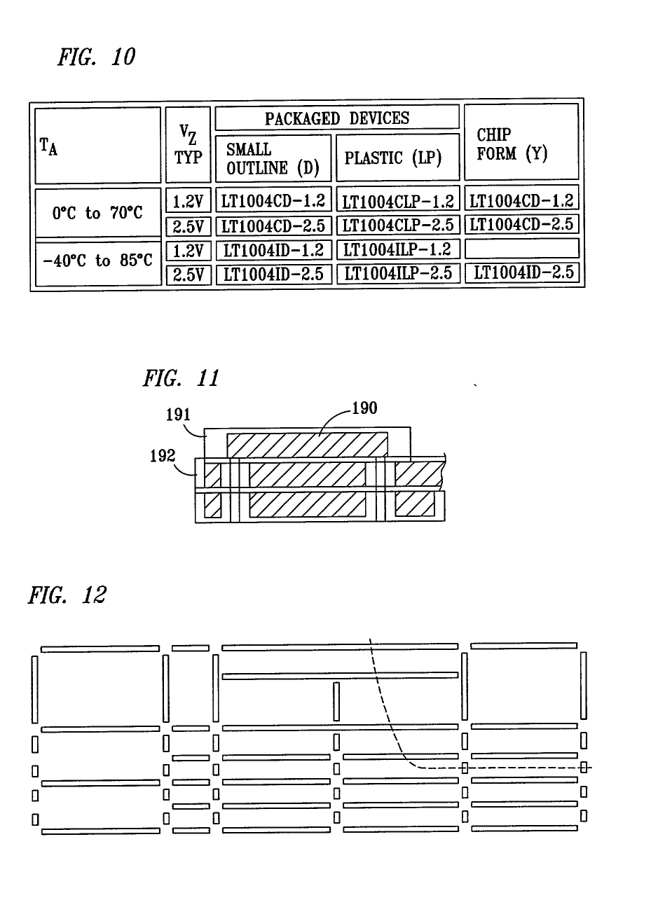

In FIG. 3, a frame is selected, as part of a looping process through all the frames in the material defined in block 12 of FIG. 1, in a block 52 and the process continues to a block 54 where various geometries are consolidated, as explained in more detail in the flow diagram of FIG. 4. In essence, the set of steps decomposes all graphical elements into simple lines each having two ends. In other words, a three-sided object or polygon, such as a triangle, would be decomposed into three independent lines. A rectangle, on the other hand, would be decomposed into four separate lines. It should be noted that in a pdf file, a straight line is considered to have a finite width and, as a graphic, a rectangle is used to provide an indication of the width and length of each line presented in the pdf file. From block 54, a determination is made in a decision block 56 whether or not the frame could possibly be a table. In block 54, all of the lines defining the data containing cells (rectangles) of a table have already been decomposed into separate lines as shown in a FIG. 12 to be discussed later. A table frame would have no curved lines and all the lines, both before and after decomposition, would be oriented in either a vertical or horizontal direction. These factors or characteristics would be used in the determination process of block 56. If it is determined that the frame is likely to be a table, a calculation is performed to determine possible table cell areas in a block 58. This process is set forth in more detail in FIG. 5. After the calculations of block 58 have been performed, the table cells are determined in a block 60. The cell sizes are determined by the amount of text or graphics that must be inserted in each cell in a row, as well as each cell in a corresponding column. Thus, the resulting table as mined, while containing all the text of the source, will not exactly mimic the source table. This may be ascertained by comparing the table at the bottom of FIG. 9B with a mined representation as illustrated in FIG. 10. Although not shown, when the mined version of a table is imported into a spreadsheet program, the placement of the text in the cells is typically again slightly altered from that shown in either FIG. 9A or in FIG. 10. The process of block 60 is set forth in more detail in FIG. 6. After block 60, the process continues to a block 61 where the frame is eliminated if it is determined that there are text quads in the frame that are not assigned to a table cell. An example of such a situation is where the component 174 of FIG. 9A is being examined as a potential table. The graphical representation for the pins and the box that describes the symbol box of block 174 will define incomplete table cells. It will find one real cell (the box representing the symbol shape) and eight empty cells (the boxes representing the pins). The text outside the center box, however, will not belong to a real table cell, but rather implied table cells that were created by cutting the encompassing rectangle.

The actions occurring in block 61 are further expanded upon in later discussed FIGS. 7 & 20. The next step is in a decision block 63 where a check is made to determine if additional unprocessed cut-lines were added during the examination of FIG. 7. If more unprocessed cut-lines are found, the process is returned to block 58 for a further calculation of table cell areas. If the examination in FIG. 7 did not generate additional unprocessed cut-lines, the next step is a block 62, where a check is made to determine if more frames are left to be examined. Now returning to block 56, if it is there determined that the contents of the frame are unlikely to be a table, the process goes directly from block 56 to block a 62. If in block 62, it appears that there are further frames to be examined, another frame is selected in a block 64 and a looping process is continued in the block 54 until all frames have been examined. If it is determined in block 62 that all frames have been examined, the next step is performed in a block 70 in FIG. 8.

FIG. 8 provides the steps for finalizing the text extraction process. In other words, the final steps are performed for special graphics and special formatting of the text detected before the invention provides any output material for use in any output document or generated visual display. This process starts with selecting or taking a frame in a block 70 and then determining in a decision block 72 whether or not there is any textual content in the selected frame. If there is, the data accompanying the extracted text is examined to detect special formatting such as super and subscripts, overbars and underlining and other special characters. The mined data is then modified such that the special formatting will be appropriately displayed in an output display monitor or document. When the selected frame is completed, a determination is made in a decision block 76 if there are more frames to be examined. If there are, a further frame is selected in a block 78 before proceeding to a decision block 72. When no more frames are detected in block 76, the process is returned to block 18 in FIG. 1 to ascertain whether or not there is more material in the source document to be examined.

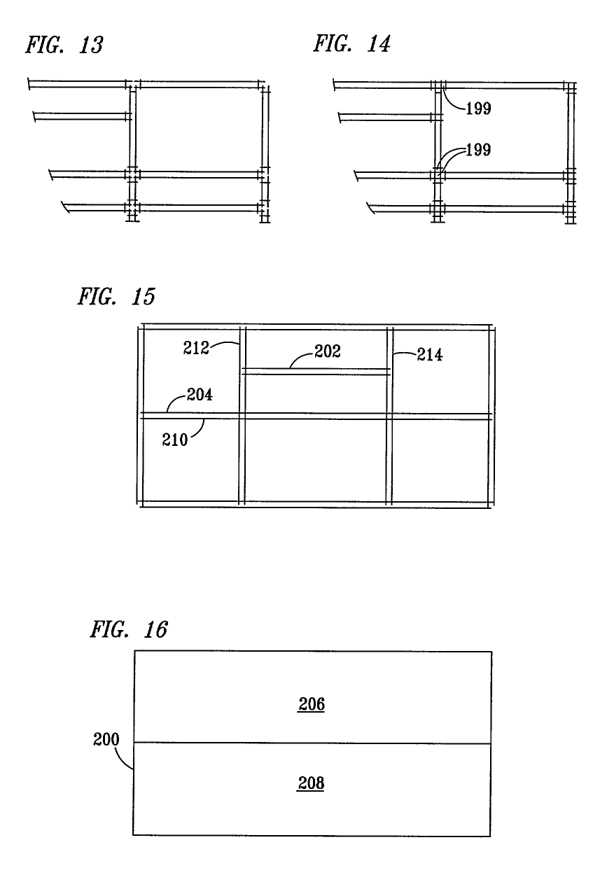

The steps presented in the flow diagram of FIG. 4 provide more detail as to how the geometries are consolidated as set forth in block 54 of FIG. 3. All polygons including rectangles are decomposed into individual lines, as stated in blocks 90, 92 and 94. It must be realized that in a pdf file, all graphics are defined by a series of lines enclosing the graphic object. While curved lines are typically represented as arcs or Bezier curves, the actual graphical rendition may well be as a set of small lines. The rendition depends very much on the device that is used to generate the document. In any case, both of these graphical elements will exclude a graphical frame from being processed as a table. A straight line in a pdf file is defined by a rectangle whose height is a direct function of the thickness of the line being defined. An intermediate block 92 indicates that any path strokes that do not constitute a closed polygon are also decomposed into individual lines. An illustrative example of each of the steps presented in blocks 90 through 94 is provided to the right of each of these blocks. Further, FIG. 13 (to be discussed later) illustrates the line graphics of a table after the decomposition of block 94. After the step of block 94, a line is selected in a block 96 and extended in length to a predetermined amount before proceeding to a decision block 98. Nearby lines that are parallel with the selected line are examined to determine if extending the selected line a further predetermined distance will connect same to the end of another line parallel to the selected line, whereby a single straight line will result. If YES, the two lines are combined into a single new line in a block 100 before proceeding to a decision block 102. By definition herein, any two (or more) such parallel lines resulting in a YES from block 98 will be referred to hereinafter as “co-joining lines,” “collinear lines” or “co-aligned lines.” If there are no co-joining lines to the selected line as determined in block 98, the block 100 is bypassed. A determination is made in a block 102 if there are any unchecked or unprocessed lines in the frame presently being examined. If so, another line is selected in a block 104 and extended in length before returning to decision block 98. As stated, the blocks 98, 100, 102 and 104 form a looping function for examining all the lines in a given frame. When all the lines in the frame have been examined and combined where co-aligned and adjoining, the process will advance to block 56 in FIG. 3. At this time, the lines representing the decomposed rectangles presented in FIG. 13 will appear substantially as shown in FIG. 14. These extended length (and including combined) lines are used in a table creation rectangle cutting process as set forth in FIG. 5 and as further explained in connection with FIGS. 15 through 18.

As previously mentioned, the action of table calculating in block 58 of FIG. 3 is set forth in more detail in FIG. 5. The table calculation process begins in a block 10 where a rectangle is created with the estimated boundary size of the table. This estimated boundary size is essentially the same as the outside lines as presented in FIGS. 12, 13 and 14. Line processing is commenced by selecting a line as set forth in a block 114 before proceeding to a decision block 116. If the selected line, overlaid on the rectangle created in block 110, would result in cutting any rectangle, including the originally created rectangle, the intersected rectangle is divided into two rectangles along the cutting line as set forth in a block 118. It should be noted that the position parameters of the selected line (as retrieved from the source document) are used to determine whether or not to make a cut and the placement length of a dividing line on the table being created. Thus, the newly created line does not extend beyond the edges of the created rectangles as would occur if the length of the selected line, used to determine cuts, were used. Another line is selected, as set forth in a block 120, and the process is returned to block 116 in a looping process to examine all lines. This dividing process will be explained further in conjunction with a discussion of FIGS. 15 through 18. If, on the other hand, the selected line is determined in block 116 to not cut a rectangle, a check is made in a decision block 122 to see if any unprocessed lines are left in the table frame being processed. If YES, another line is selected in the block 120. This process is repeated in an iterative looping manner until a loop of all remaining unprocessed lines is made and no more rectangles are generated. When all lines have been processed by the looping action of blocks 116, 118, 120 and 122, such that a NO determination is made in block 122, the process continues to a block 124 where all unprocessed remaining lines that could not be used for cutting subsequent rectangles are marked or flagged as “unprocessable.” Empty cells are then removed in a block 126 before proceeding to block 60 of FIG. 3.

As may be determined from an examination of FIG. 14, various small rectangles, such as those designated as 199, are created when the co-aligned lines are combined. These small rectangles will be caused to be recreated in the table creation cutting process of FIG. 5. For the most part, these small rectangles are the ones removed in block 126 and not ones big enough to hold text, such as the empty cell in the penultimate row of the last column of FIG. 10.

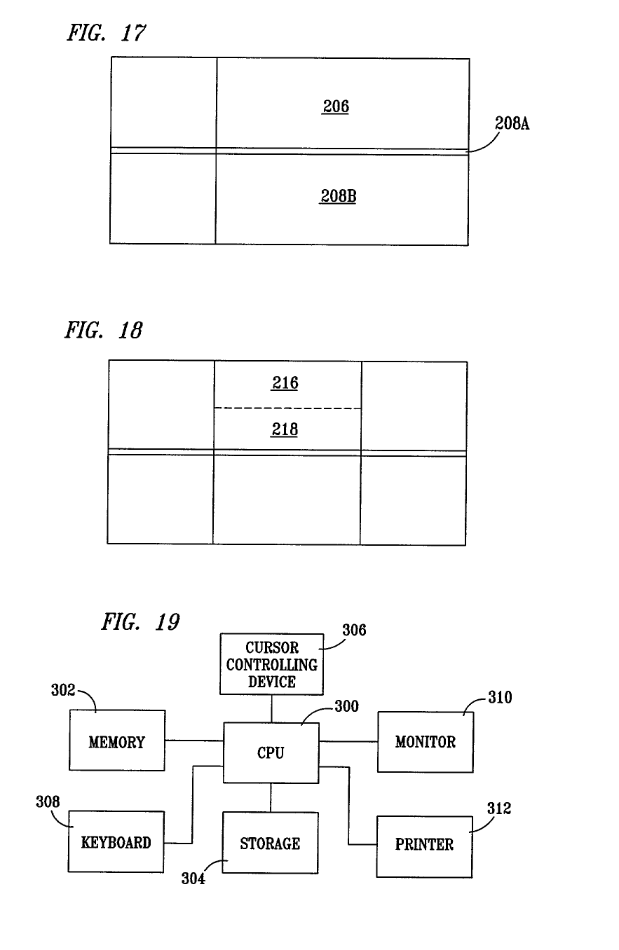

To further explain the process of FIG. 5, a set of FIGS. 15, 16, 17 and 18 will now be discussed in connection with FIG. 5. It may be assumed that FIG. 15 comprises a very simple table wherein each of the lines have been selected, extended and the co-aligned lines have been combined in accordance with FIG. 4. In FIG. 16, a rectangle 200 is presented as the estimated table boundary as mentioned in connection with block 110. This boundary will initially be substantially the same size as the perimeter of the set of lines in FIG. 15. It may be assumed that a first line picked is line 202 of FIG. 15. The decision block 116 would determine that at this time it does not split or cut any rectangles. The line would be marked as unprocessed and left for selection again after all the remaining lines have been examined. If line 204 is the next line selected (step 120), the created rectangle would now look like that presented in FIG. 16, since line 204 cuts original rectangle 200 into two rectangles 206 and 208. The dividing line of FIG. 16 does not, however, extend beyond the boundaries of the created rectangle 200. If line 210 is next selected, the rectangle 208 will now be cut into a very small 208A and a comparatively large rectangle 208B. This result is presented as part of FIG. 17. If a line designated as 212 in FIG. 15 is next selected, the three rectangles generated by the cutting from lines 204 and 206 will now result in six rectangles, as presented in FIG. 17. A further selection of line 214 will cause the table being created to appear as shown in FIG. 18. As more lines are selected, the table being created will approach the shape of the table originally presented in the source file. When line 202 is again examined, a determination will be made that two more rectangles 216 and 218 are created, as shown by the dash line of FIG. 18.

A block 130 in FIG. 6 represents the next step after block 58 of FIG. 3. In accordance with block 130, the cells in the table, of the frame presently being examined, are sorted from left to right and top to bottom. The next step, in a block 132, is to select the first cell. This, in view of the sorting operation of block 130, would be the cell in the upper left hand corner. The next step, presented in a block 134, is to calculate how many rows are spanned by this cell. Referring to FIG. 10, it may be noted that the upper left cell (containing the text “T_{A}”) spans two rows. The next step, in a block 136, is to determine how many columns are spanned by the selected cell. Again referring to FIG. 10, it may be noted that the selected cell spans only one column. The next step of FIG. 6 is a decision block 138, where a check is made to determine if there are any more cells. If there are, the next step is a block 140, wherein a further unprocessed cell is selected. If, in block 138, it is determined that the last block in the lower right hand corner has been processed, the process goes to a block 61 of FIG. 3, which is expanded upon in FIG. 7.

The purpose of the steps in FIG. 7 is to eliminate, from further possible table consideration, any frames incorrectly assumed to contain a table. An initial step, set forth in a decision block 149, is to check for any unprocessable lines as marked in block 124 of FIG. 5. If not, the next step, in block 150, is to select a first text quad. Next, in a decision block 152, a determination is made as to whether or not the selected text quad is assigned to a table cell. If not, in a further block 154, the presently selected frame is eliminated from the list of frames possibly containing a table, and the process continues through a decision block 63 to block 62 of FIG. 3 to see if there are any more unprocessed frames. The block 154 may also be entered directly from block 149 in those instances where a determination is made in decision block 149 that unprocessable lines have been found in the frame presently under consideration. If, in block 152, there is a YES determination, a decision block 156 is entered to determine if there are more unprocessed text quads. If there are more, another text quad is selected in a block 158 and a return is made to block 152 until all text quads are processed or until a text quad is found that is not assigned to a table. When all the text quads have been processed according to block 156, the process continues to a block 157 (more fully detailed in FIG. 20) where a determination is made as to whether or not the table is configured such that virtual cut-lines should be generated to better present data in the table. From block 157, the process continues to block 63 in FIG. 3.

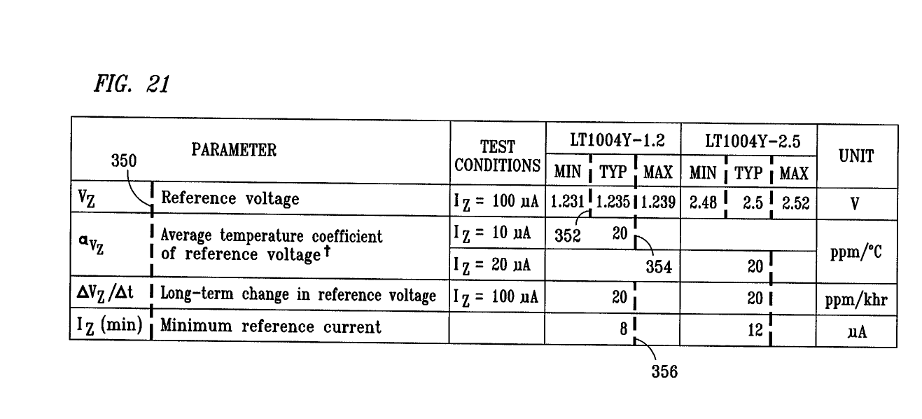

Reference will now be made to both FIGS. 20 and 21 in the following discussion. In order to vertically align text in a destination document generated table where the source document contains a table that is constructed or otherwise looks like FIG. 21 but does not have the dash lines that are shown in FIG. 21, virtual cut-lines need to be generated. Such a table in a source document may be referred to as having multiple columns of data in a single column of cells. The segregated sets or columns of data in the single column of cells need not appear in every row and some rows in the column may be blank with data above and below the blank cell. These virtual cut-lines are used in positioning text in the destination document within a column. References to these virtual cut-lines (dash lines) are placed in the mined document but are not visually apparent in the destination document generated therefrom except for the alignment of text within cells of a column wide enough to contain multiple, but segregated pieces of data.

A block 320 in FIG. 20 states that a first column is selected in a table being examined, such as the column with “PARAMETER” in FIG. 21. A block 322, after block 320, recites the step of “take 1^{st} row.” The first row in this column is the cell containing the word “PARAMETER”. The next step is in a decision block 324 where a check is made to see if the text quad (not having a previously assigned virtual cut-line adjacent thereto) containing the word “PARAMETER” is aligned on the left side with a text quad in a previous row in this column. Since this is the top row, there is no previous row to check against. However, if previous row text quad boundaries were found, the next step would be in a block 326, where virtual cut-lines are assigned as a new unprocessed line adjacent both the present quad set and the previous quad set as found in block 324. As will be apparent, this will at times overwrite a virtual cut-line already established by a previous step in this flow diagram. If the determination in block 324 is NO, the next step, in a block 328, is to check to see if a boundary of a text quad (not having a previously assigned virtual cut-line adjacent thereto) in this cell is aligned on the right side with a text quad in a previous row. If YES, the process returns to block 326. As may be ascertained from the column starting with “LT1004Y-1.2”, the cells below have multiple virtual cut-lines shown as dash lines. When this column and row is reached, a cut-line 352 is assigned on the first loop and a cut-line 354 is assigned on the second loop. Since the text quads are aligned on the right side, the assignment occurs after leaving decision block 328. When there are no more text quads found aligned with previous text quads by blocks 324 and 328 in a given row and column, the process continues to a decision block 330 to ascertain if there are more rows left in the selected column. If YES, the next step is in a block 332 where the next row in the column is selected. In this case, the next row has a text quad “V_{z}” and a text quad “Reference”. The word “voltage,” from the oversizing and combining operation, would be associated and a part of the text quad “Reference”. Since there is nothing aligned with either of the text quads in this row, the process passes through blocks 324, 328 and 330 to pick the next row in block 332. At this time, it is determined that while the text quad “^{α}V_{z}” is aligned on the left with “V_{Z}”, this term already has a cut-line defining the left edge as a perimeter line of the table. Thus, the text quad starting with “Average” is found to be aligned with “Reference” on the left side and the process goes from block 324 to block 326 to establish an upper portion of a cut-line 350 for the two rows checked thus far. The next two loops through the last two rows in the column will extend the virtual cut-line 350 to the bottom of the table as shown. At this time, the decision block will determine that there are no further rows in the first column and thus proceed to decision block 334. Since there are further columns, the next column having a title starting with “TEST” will be selected by block 336. No further virtual cut-lines will be found, however, until the next column. As mentioned supra, the column entitled “LT1004Y-1.2” will be found to have two sets of virtual cut-lines. The lines 354 and 356 may be considered one set even though not connected. The top portion of line 356 will be assigned when examining the penultimate row of this column, since a right hand alignment is ascertained with one or more text quads that have the line 354 assigned thereto. When the last column entitled “UNIT” is selected, no assignment of cut-lines occur and a NO decision is made in block 334 for columns left and the process continues to block 63 of FIG. 3 to continue the process of determining additional table cells.

FIGS. 9A and 9B represent the top and bottom of a page of a source document comprising either a portion of a range or a range of material, as selected in block 12 of FIG. 1, of a visually displayable document. As mentioned above, a pdf file encloses words or portions of words and graphics or separate portions of a graphic in separate quads. The quads are oversized in block 32 of FIG. 2 and overlapping quads are then consolidated into frames as set forth in the remainder of FIG. 2. In FIGS. 9A and 9B, a frame 160 encloses the title of this document. A frame 162 encloses a graphic including a blank subframe designated as 163 representing further document information (revision date and so forth) that, due to its proximity to the extended line of the graphic of frame 162, was included in the frame 162 by the program of the present invention. Various further blank frames designated as 164 represent further text distributed around the document which is processed in accordance with the flow diagrams. The frames 164 are left blank to simplify the presentation of the invention. Various text title blank frames 166 are also shown. An upper portion of a frame 168 is shown in more detail in FIG. 11 to be explained in more detail later. A frame of text 170 is also shown in detail. The extraction process, in one embodiment of the invention, did not concern itself with the format of the paragraph, but rather merely extracted the material in this frame, as shown below, where the extraction process happened to select this portion of the range as the 20^{th} frame. The following represents what appears in a “mined” document and is written in XML format.

<!-- Frame: frame-20 -->
<frame bBox=“(5877793 29234251) (19932203 35479421)”
viewType=“textOnly”>
<font.reference idref=“Helvetica-10”/>The LT1004 micropower voltage
reference is a two-terminal band-gap reference diode designed to provide
high accuracy and excellent temperature characteristics at very low
operating currents. Optimizing the key parameters in the design,
processing, and testing of the device results in specifications previously
attainable only with selected units.</frame>

From the above, it may be determined that the location of the frame (bBox), the contents (text only), and the font data is recorded for use in the output document. In an output document, the text of frame 20 may be reformatted to fit in a box of the size recorded in the extraction process or the formatting may be modified in accordance with parameters within the program, such as a word processing program.

A frame designated as 174 represents a component with pin labels. The process for extracting data from such a component is provided in more detail in the referenced patent application mentioned supra. The extraction process would be identical in this invention after oversizing quads and defining frames, as set forth in FIGS. 1 and 2. A frame, designated as 176, represents a further component view which would merely be extracted as a graphic and text, since labels and pins are not presented in such a manner to be ascertained in the extraction process as a component having pins and labels. As will be realized from observation by those skilled in the art, this frame includes arcs or Bezier lines. The detection of such lines precludes this frame from being extracted for symbol pin contents. Further, there are no identifiable pin numbers in the diagram of this frame. The connections in this case are defined by the shape of the symbol rather than a well-defined pin numbering mechanism.

A graphic 176 in the lower left hand portion of FIG. 9B would be treated as a graphic without text in a manner substantially the same as the component graphic 176 in FIG. 9A.

A frame 178, also in FIG. 9B, encloses a further graphic frame. In a pdf file, the diode (of this frame) would likely be segregated into four quads, wherein two would be the beginning and ending lines, a third would be a triangle representing the anode and a fourth would be the crooked line representing the cathode. With reference to FIG. 4, it may be ascertained that the decomposition of the two lines of frame 178 would occur in accordance with block 94, the anode with block 90 and the cathode with block 92.

A frame 180 encloses a series of text and line quads. An examination of this frame, in accordance with decision block 56, would reveal that the only graphics contained in this frame comprise horizontally and vertically oriented lines and the remainder of the quads contain text. Thus, it would be treated as a table in accordance with the procedure set forth in FIGS. 5 and 6. If the quads contained in frame 164 immediately below frame 180 were a little closer to frame 180, and if it were a graphic containing only horizontal and/or vertical lines, the oversizing steps of FIG. 2 could cause these quads to be included within frame 180. Thus, the resulting frame would include the text of this block 164. If this happened, the table would have to be separately defined as a range and the results separately inserted in the output documentation. An alternative, but more manually intensive and a less desirable approach, is to manually remove this text from the mined document.

A comparison of format of the text in the frame of the source document illustrated in frame 180 of FIG. 9B and the frame as created in conjunction with the steps of FIGS. 5 and 6 will show slight differences. This may occur when the program examines the amount of text that needs to be inserted in each row and column and font size and generates a table occupying the minimum amount of space required to present the text. Also, position formatting data supplied in a pdf file may be inferior (or undecipherable) to that used in an XML or html compatible word processor.

The detail in FIG. 11 represents some of the steps in the quad oversizing and polygon assignment steps of FIG. 2 to generate a frame. The upper cross-hatched portion of this figure is designated as 190 and represents the word “Applications” in frame 168 of FIG. 9A. When the quad containing this word is oversized, a rectangle, designated as 191, is created. If this is the first selected quad after completing the frame 164 immediately above frame 168, the rectangle 191 also represents a polygon as created in block 42. If the “-” in front of the word “Portable” is the next quad selected, it will be determined that the oversized quad, designated as 192, intersects polygon 191, thus quad 192 is assigned to polygon 191 in accordance with block 38. The next selected quad may be the quad enclosing the cross-hatched area representing the word “Portable” and since it intersects both the original and the enlarged polygon 191, it is assigned to a further enlarged polygon. The process continues as each quad with the frame shown as 168 is added to the enlarged polygon. An examination of the remaining nearby quads will ascertain that no more quads intersect this frame; thus, the expansion of polygon 191 will stop with the size shown for frame 168 and new frames, such as nearby frames 164 and 166, will be generated in the looping process of FIG. 2.

FIG. 12 is a representation of the table shown in FIG. 9B frame 180 where the width of the lines defining the cells of the table are exaggerated to better illustrate the operation of the present invention. A dash line in the upper right hand portion defines an area of the table shown in more detail in FIGS. 13 and 14.

As previously mentioned, a pdf file represents a straight line as a rectangle having a thickness of the line presented. This rectangle is then circumscribed by a quad. Thus, FIG. 13 is intended to show the outline of lines in the upper right hand portion of FIG. 12 above the dash line after the rectangle decomposition of block 94, the line extension of blocks 96 and 104, but without the line combining of block 100 in FIG. 4. As will be realized, the line extension may alternately take place during decomposition rather than in blocks 96 and 104. When the combining of co-aligned lines takes place, as set forth in block 100, all of the lines to be used in generating a table will look substantially the same as shown in FIG. 14 or as shown in FIG. 10 except for the length of the lines.

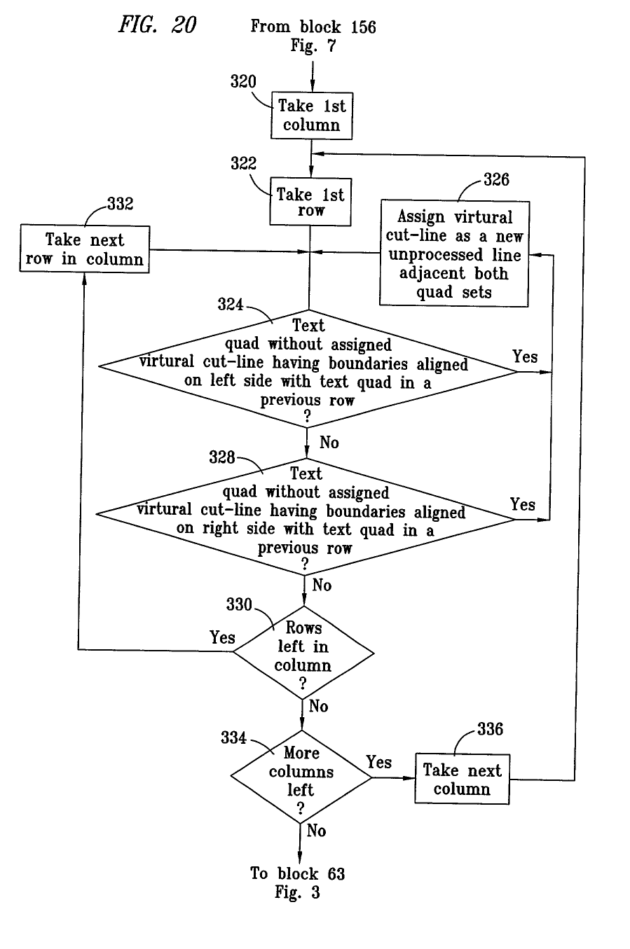

In FIG. 19, a CPU 300 is illustrated having internal or external memory 302 and data storage 304. Storage apparatus 304 may comprise both internal and removable storage means. Such removable storage may be used to install programs and to transfer output or destination data files generated as a result of using this invention to other devices. The CPU 300 is further connected to a cursor controlling device 306, such as a mouse, trackball and so forth. The CPU 300 is further connected to a keyboard 308, a monitor 310 and a printer 312 for entering commands, viewing file contents and program results and printing output, respectively.

Although the invention has been described with reference to specific embodiments, these descriptions are not meant to be construed in a limiting sense. Various modifications of the disclosed embodiments, as well as alternative embodiments of the invention, will become apparent to persons skilled in the art upon reference to the description of the invention. It is therefore contemplated that the claims will cover any such modifications or embodiments that fall within the true scope and spirit of the invention.

What is claimed is:

1. A method of extracting data from a source document wherein words, portions of words and graphic elements are circumscribed by polygons hereinafter referred to as quads, comprising the steps of:
oversizing each quad in a predetermined range of the document;
selecting a first quad;
a. determining if said selected first quad intersects and thus overlaps a second quad:
i. if overlap is detected, assigning said second quad to the selected first quad, thereby creating a total polygon area larger than either original entity; and
ii. if overlap is not detected, creating an encompassing polygon including said selected first quad;
b. merging the newly created or enlarged polygon (of step “a”) with any other polygon found to overlap with the step “a” polygon;
repeating steps “a” and “b” for any further unassigned quads left in said predetermined range and not encompassed by a polygon;
selecting a first frame of quads assigned to a polygon;
c. decomposing all graphical elements within the selected frame into straight lines;
d. assembling components of the selected frame into a table when examination of the decomposed frame indicates a predetermined arrangement of table cell defining straight lines; and
repeating steps “c” and “d” for identifying any possible table in any remaining frames of assigned quads.

2. The method of claim 1 wherein:
step c includes retaining relative placement data of each decomposed line as obtained from the source document; and
step d comprises the additional sub-steps of:
combining co-aligned lines in the frame;
creating a rectangular table boundary;
splitting any previously formed rectangle determined to be cut by any selected co-aligned line inserted into said rectangular table boundary to create at least two new rectangles; and
removing any created rectangle whose interior would not include at least one text quad.

3. A method of mining data from a visually displayable source document having quads defining textual and graphics elements, comprising the steps of:
combining quads, having less than a predetermined separation, into frames;
generating textual paragraphs, in an output document, from frames detected to contain only textual and textual associated symbols; and
generating tables, in said output document, from frames detected to contain only vertically and horizontally oriented straight lines enclosing textual and textual associated symbols.

4. A method of eliminating a group of quads in a source document, each quad of which is relatively situated within a predetermined distance of each other, as potentially defining a table of data, comprising the steps of:
decomposing all graphic elements in said group of quads into straight lines;
determining the orientation of each of said straight lines; and
eliminating said group of quads where any of said straight lines is oriented other than horizontal and vertical.

5. A method of eliminating a group of quads in a source document, each quad of which is relatively situated within a predetermined distance of each other, as potentially defining a table of data, comprising the steps of:
decomposing all graphic elements in said group of quads into straight lines;
combining any decomposed co-aligned lines into a new set of straight lines;
creating a rectangular table perimeter;
cutting said rectangular table perimeter into smaller rectangles using said straight lines whereby a plurality of cells are created;
removing rectangles not circumscribing a text quad of said group of quads;
eliminating said group of quads, as potentially defining a table, if any text quad is not circumscribed by a rectangular cell.

6. A method of establishing that a group of quads in a source document, each of which is relatively situated within a predetermined distance of each other, potentially defines a table of data, comprising the steps of:
decomposing all graphic elements in said group of quads into straight lines; and
determining that the orientation of each of said straight lines is either horizontal or vertical.

7. The method of claim 6, comprising the additional steps of:
combining any decomposed co-aligned lines into a new set of straight lines;
creating a rectangular table perimeter;
cutting said rectangular table perimeter into smaller rectangles using said straight lines whereby a plurality of cells are created; and
eliminating said group of quads if any text quad is not circumscribed by a rectangular cell.

8. A method of recreating a table in a destination document from a visual display file using quads to encompass textual and graphics elements, comprising the steps of:
combining all groups of closely spaced quads into a polygon frame;
eliminating all frames from further potential table consideration that contain graphic decomposed lines oriented in other than vertical and horizontal;
replacing co-aligned lines, resulting from decomposition of graphics, with a single line;
recreating a table using decomposed replaced and unaltered lines to create cells; and
eliminating frames where textual quads are outside table created cells.

9. A method of converting information in a visual display file using quads to a word processing software compatible type document, comprising the steps of:
combining all groups of quads spaced within a first predetermined distance of one another and comprising at least one of textual symbols and textual associated symbols into an expandable polygon frame;
combining all groups of quads in each frame that are spaced within a second predetermined distance, which second predetermined distance is less than said first predetermined distance, into words; and
converting each of the frames into a word processing type output document.

10. A method of converting table related information, in a visual display source file using quads, to a spreadsheet importable type document, comprising the steps of:
combining all quads of the table related information in the visual display file into a frame;
oversizing all graphic quads in the frame;
decomposing all oversized graphic quads into straight lines;
creating a rectangle of substantially the same size as the table in the visual display document;
replacing co-aligned lines of said straight lines, resulting from decomposition of graphics, with a single line;
recreating a table using decomposed, replaced and unaltered lines to create cells;
inserting textual quads within created cells occupying substantially the same relative space in the created rectangle as it did in the table of the visually displayed source file; and
generating a mined document describing the composition of the created rectangle and the placement of text therein.

11. A method of converting information in a range of visual display file textual matter, comprising multiple paragraphs of text, using quads into separate paragraphs of data in a mined document, comprising the steps of:
combining all groups of quads spaced within a first predetermined distance of one another and comprising at least one of textual symbols and textual associated symbols into an expandable polygon frame;
combining all groups of quads in each frame that are spaced within a second predetermined distance, which second predetermined distance is less than said first predetermined distance, into words; and
converting each of the frames into a separate paragraph in a mined output document.

12. Apparatus for extracting data from a source document wherein words, portions of words and graphic elements are circumscribed by polygons, hereinafter referred to as quads, comprising:
means for oversizing each word and graphic quad in a selected range of the document;
means for assembling quads that overlap into frames;
means for decomposing all graphical elements within each frame into straight lines; and
means for assembling components of any frame into a table when examination of the decomposed elements in a frame indicates a predetermined arrangement of table cell defining straight lines.

13. Apparatus as claimed in claim 12, comprising in addition:
means for retaining relative placement data of each decomposed line as obtained from the source document;
means for combining any co-aligned straight lines after decomposition in a frame ascertained to comprise a table;
means for creating a rectangular table boundary in a frame ascertained to comprise a table;
means for splitting any previously formed rectangle determined to be cut by any selected co-aligned line inserted into said rectangular table boundary to create at least two new rectangles; and
means for generating a mined document from which data may be displayed.

14. Apparatus for mining data from a visually displayable source document having quads defining textual and graphics elements, comprising:
means for combining quads, having less than a predetermined separation, into frames;
means for generating textual paragraphs, in an output document, from frames detected to contain only textual and textual associated symbols; and
means for generating tables, in said output document, from frames detected to contain only vertically and horizontally oriented straight lines enclosing textual symbols.

15. Apparatus for eliminating a group of quads in a source document, each quad of which is relatively situated within a predetermined distance of each other, as potentially defining a table of data, comprising:
means for decomposing all graphic elements in said group of quads into straight lines;
means for determining the orientation of each of said straight lines; and
means for eliminating said group of quads where any of said straight lines is oriented other than horizontal and vertical.

16. Apparatus for establishing that a group of quads in a source document, each of which is relatively situated within a predetermined distance of each other, potentially defines a table of data, comprising:
means for decomposing all graphic elements in said group of quads into straight lines; and
means for determining that the orientation of each of said straight lines is either horizontal or vertical.

17. Apparatus as claimed in claim 16, comprising in addition:
means for combining any decomposed co-aligned lines into a new set of straight lines;
means for creating a rectangular table perimeter;
means for cutting said rectangular table perimeter into smaller rectangles using said straight lines whereby a plurality of cells are created; and
means for eliminating said group of quads as a potential table if any text quad is not circumscribed by a rectangular cell.

18. Apparatus for recreating a table in a destination document from a visual display file using quads to encompass textual and graphics elements, comprising:
means for combining all groups of closely spaced quads into a polygon frame;
means for eliminating all frames from further potential table consideration that contain graphic decomposed lines oriented in other than vertical and horizontal;
means for replacing any set of co-aligned lines, resulting from decomposition of graphics, with a single line;
means for recreating a table using decomposed replaced and unaltered lines to create cells; and
means for eliminating frames as table candidates where textual quads are outside table created cells.

19. Apparatus for converting information in a visual display file using quads to a word processing software compatible type document, comprising:
means for combining all groups of quads spaced within a first predetermined distance of one another and comprising at least one of textual symbols and textual associated symbols into an expandable polygon frame;
means for combining all groups of quads in each frame that are spaced within a second predetermined distance, which second predetermined distance is less than said first predetermined distance, into words; and
means for converting each of the frames into a word processing type output document.

20. Apparatus for converting table related information, in a visual display source file using quads, to a spreadsheet importable type document, comprising:
means for combining all quads of the table related information in the visual display file into a frame;
means for oversizing all graphic quads in the frame;
means for decomposing all oversized graphic quads into straight lines;
means for creating a rectangle of substantially the same size as the table in the visual display document;
means for replacing co-aligned lines of said straight lines, resulting from decomposition of graphics, with a single line;
means for recreating a table using decomposed, replaced and unaltered lines to create cells;
means for inserting textual quads within created cells occupying the same relative space in the created rectangle as it did in the table of the visually displayed source file; and
means for generating a mined document describing the composition of the created rectangle and the placement of text therein.

21. Apparatus for converting information in a range of visual display file textual matter, comprising multiple paragraphs of text, using quads into separate paragraphs of data in a mined document, comprising:
means for combining all groups of quads spaced within a first predetermined distance of one another and comprising at least one of textual symbols and textual associated symbols into an expandable polygon frame;
means for combining all groups of quads in each frame that are spaced within a second predetermined distance, which second predetermined distance is less than said first predetermined distance, into words; and
means for converting each of the frames into a separate paragraph in a mined output document.

22. A method of recreating a table in a destination document from a visual display source file using quads to encompass textual and graphics elements, comprising the steps of:
replacing, in a frame, co-aligned lines, resulting from decomposition of graphics, with a single line;
recreating a table using decomposed replaced and unaltered lines to create cells;
inserting textual quads into cells corresponding to the table location of the textual quad in the source file; and
eliminating rectangles of substantially less than the size of the smallest cell containing a textual quad.

23. A method of positioning textual quads in a column of cells at least some of which contain multiple columns of data in a single column of cells, comprising the steps of:
checking every cell of a source document derived table frame for cells having segregated sets of textual symbol quads;
assigning virtual cut-lines to textual quads that are aligned with textual quads in prior similar size cells in a given column; and
using the virtual cut-lines in aligning textual matter in an output document.

24. Apparatus for recreating a table in a destination document from a visual display source file using quads to encompass textual and graphics elements, comprising:
means for replacing, in a frame, co-aligned lines, resulting from decomposition of graphics, with a single line;
means for recreating a table using decomposed replaced and unaltered lines to create cells;
means for inserting textual quads into cells corresponding to the table location of the textual quad in the source file; and
means for eliminating rectangles of substantially less than the size of the smallest cell containing a textual quad.

25. Apparatus for positioning textual quads in a column of cells at least some of which contain multiple columns of data in a single column of cells, comprising:
means for checking every cell of a source document derived table frame for cells having segregated sets of textual symbol quads;
means for assigning virtual cut-lines to textual quads that are aligned with textual quads in prior similar size cells in a given column; and
means for using the virtual cut-lines in visually aligning textual matter in an output document.
